(19) United States
(12) Patent Application Publication
(10) Pub. No.: US 2021/0027174 A1
(43) Pub. Date: Jan. 28, 2021

(54) RANDOMIZATION OF CASE-BASED KNOWLEDGE TO RULE-BASED KNOWLEDGE

(71) Applicant: The United States of America as represented by the Secretary of the Navy, San Diego, CA (US)

(72) Inventor: Stuart H. Rubin, San Diego, CA (US)

(21) Appl. No.: 16/523,026

(22) Filed: Jul. 26, 2019

(51) Int. Cl. G06N 5/02

(52) U.S. Cl. CPC G06N 5/022

(57) ABSTRACT

Case-based information is randomized to rule-based information by accessing a case base to obtain a plurality of sets of variables representing case-based input/output constraints associated with corresponding cases. A matching is initiated, of a candidate case with one or more contexts of items included in a knowledge repository storing a plurality of cases and a plurality of rules that are organized in segments according to a plurality of domains and are comingled. At least one of the cases of the plurality of cases is generalized.

### FEDERALLY-SPONSORED RESEARCH AND DEVELOPMENT

The United States Government has ownership rights in this invention. Licensing inquiries may be directed to Office of Research and Technical Applications, Naval Information Warfare Center, Pacific, Code 72120, San Diego, Calif., 92152; telephone (619)553-5118; email: ssc_pac_t2@navy.mil. Reference Navy Case No. 104,105.

### BACKGROUND

Systems for case-based knowledge acquisition may utilize case data based on situations, contexts of the situations, and consequents. While case-based reasoning may be advantageous for particular situations, it may be desirable to make case-based knowledge more general. For example, it may be desirable to extend cases by analogical processes, and/or to adapt case actions to suit similar situations. However, conventional techniques may include a human in the loop to supply new knowledge (e.g., expert systems), may validate hypothetical knowledge (e.g., inductive inference), may extract features from the knowledge (e.g., genetic algorithms (GAs) and neural networks) and/or transform existing knowledge (including its representation thereof). For example, with regard to the representation, techniques for Knowledge Amplification with Structured Expert Randomization (KASER) are discussed in U.S. Pat. No. 7,047,226, to Rubin, S. H., which issued May 16, 2006, hereby incorporated by reference herein in its entirety (“'226 patent” hereinafter). As discussed therein, randomization theory holds that the human should supply novel knowledge exactly once (i.e., random input) and the machine extend that knowledge by way of capitalizing on domain symmetries (i.e., expert compilation). In the limit, novel knowledge may be furnished only by chance itself. The term “randomization” generally as used herein, is further discussed in Chaitin, G. J., “Randomness and Mathematical Proof,” Scientific American, 232 (5), pp. 47-52, 1975 (“Chaitin” hereinafter), and in Rubin, S. H., “On Randomization and Discovery,” J. Information Sciences, Vol. 177, No. 1, pp. 170-191, 2007 (“Rubin 2007” hereinafter). Additionally, adaptive case-based reasoning is further discussed in U.S. Pat. No. 8,447,720, to Rubin, S. H., which issued May 21, 2013, hereby incorporated by reference herein in its entirety (“'720 patent” hereinafter).

### SUMMARY

According to one general aspect, a method may include randomizing case-based information to rule-based information by accessing a case base to obtain a plurality of sets of variables representing case-based input/output constraints associated with corresponding cases. A matching is initiated, of a candidate case with one or more contexts of items included in a knowledge repository storing a plurality of cases and a plurality of rules that are organized in segments according to a plurality of domains and are comingled. At least one of the cases of the plurality of cases is generalized.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an embodiment of a distributed processor system.

FIG. 2 illustrates a system for randomization of case-based knowledge to rule-based knowledge that may reside on the system shown in FIG. 1.

FIG. 3 illustrates a system for segmented knowledge amplification that may reside on the system shown in FIG. 1.

FIG. 4 is a flowchart illustrating randomization of case-based knowledge to rule-based knowledge.

### DETAILED DESCRIPTION

Example techniques discussed herein may minimize the need for human intervention by using cases (and rules) as I/0 constraints and applying self-referential randomization to maximize the reusability of the case knowledge. The techniques are derived using self-reference and randomization. A system in accordance with the discussion herein may increase its own knowledge base through transformation (e.g., as may be contrasted with mining operations, which may incorporate external data, and external knowledge). A problem solved by the discussion herein may pertain to knowledge amplification by way of taking existing knowledge and making it more reusable.

As discussed above, issues may arise in automated systems that utilize case-based reasoning to obtain knowledge from processed data. While case-based reasoning may be advantageous for particular situations, it may not yield desirable results in many other situations. Example techniques discussed herein may generalize knowledge through self-application (e.g., randomization). As discussed herein, knowledge may be defined to be a sequence of symbols, which define the actions of a fixed interpreter. Such sequences map a set of mutually random inputs to an associated non-deterministic set of outputs. By setting these inputs to these sequences and their associated outputs to their randomized sequences, the mapping sequences may be capable of randomizing domain-specific knowledge. Such generalization may be iteratively performed through the coherent actions of many such sequences. In effect, declarative knowledge may be exponentially reduced and mapped to procedural knowledge. Example techniques discussed herein may be applied to mapping a case base to a rule base. Knowledge, in the form of cases (i.e., unlike rules), may be readily captured. As discussed herein, case-based knowledge may be automatically randomized into rules, thus enabling greater reusability. For example, this may be evidenced as autonomous knowledge-based creativity in practice.

A case base includes a set of situations and a sequence of actions such that the set is mapped to an appropriate sequence by way of experience, which may provide information referred to as experiential knowledge. Cases differ from rules in that individual cases embed causality, but do not literally state, with minimal context, it as do rules. A potential problem is that it is generally impossible to directly capture causality. Any attempt to do so (e.g., through the use of rules) may lead to secondary interactions, which may grow to become ever-more difficult to predict with scale. Cases are not associated with this difficulty because they are limited to the capture of experience, which may differ from the underpinning cause and effect. Case bases may also be less costly to maintain, for this reason.

An example of using such techniques may include application to the domain of weather forecasting to illustrate its utility for relevant domains. Further, a user may integrate scalable reusable functional programming with the approach, thus making for extensible intelligent systems.

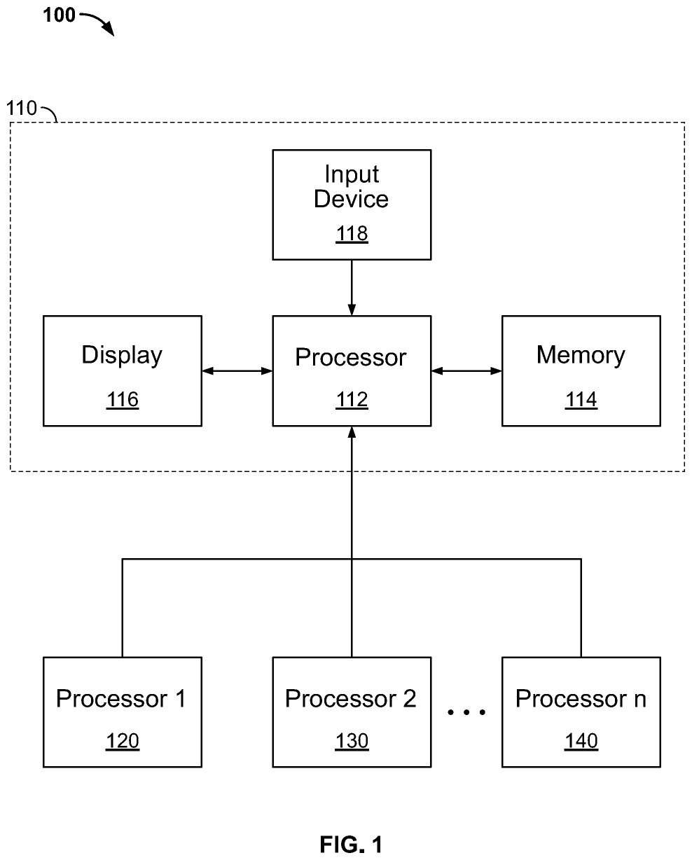

FIG. 1 is a block diagram of an embodiment of a distributed processor system 100 in accordance with example techniques discussed herein. For example, the speed of a case-based reasoning system can be increased through the use of associative memory and/or parallel (distributed) processors, such as shown in FIG. 1. Furthermore, an increase in speed can be obtained if information stores are subdivided for the case knowledge by domain for threaded parallel processing, which may be referred to as segmenting the domain. Such segmentation can be automatically managed by inferred symbolic heuristics, but this may introduce redundancy into the system (albeit brain-like). For example, a candidate case to be acquired may be matched against a dynamic case residing at the head of each segment. This case may be acquired by those segments, whose head most closely matches it based on their possibilities.

Moreover, it may be acquired by all segments whose current head is within a predetermined threshold value of this new case, where the threshold may be dynamically defined by the minimal possibility differential among case-based heads. However, whenever the computed possibility between the new case and the case-based heads is greater than the current maximum among case-based heads, so that the new case falls outside of existing segments, the case may be acquired by creating a new segment (i.e., given sufficient parallel nodes/space). Otherwise, the least-recently-used (LRU) segment may be expunged, to free space, and replaced. Thus, a system, such as system 100, may be cold-started with a pair of non-redundant segments.

Further, given a system such as system 100, it is possible for one or more computers to chat back and forth with each other if the output of each can serve to augment the input for another. This process is also brain-like because here the cases may acquire knowledge on how to solve a problem (e.g., by way of asking questions), and not just domain-specific knowledge. This respects the mathematical process of randomization. Every consequent (or response to a consequent) may be either terminal or non-monotonic in its action—as determined by whether or not it elicits additional knowledge from the user (or other subsystem) to augment the on-going context. The consequent(s) produced by this iterative feedback process may be corrected, as necessary. This may be referred to as knowledge amplification, because knowledge begets knowledge. That is, knowledge imbued along one path of reasoning becomes subsumed along other paths of reasoning.

A word matching algorithm may visit the unknown cases too, or they may never be corrected. Feedback may take two forms: 1) consequents may raise questions, the answers to which, supplied by the users, serve to augment the context, and 2) the consequents themselves may literally augment the context—again, under user control. The fact that antecedents and consequents can share the same space implies that words for both share the same words table.

Classical set theory does not allow for duplication of elements in the context or antecedent. However, sentential forms are sequence sensitive and thus differ from sets. For example, if someone states, “location”, one might think of a map; but, if someone states, “location, location, location”, one may instead think of real estate. It may be desired that a system be capable of making use of such sequence in matters of practical feedback. However, contextual duplicate words may not be counted because to do so would proportionately decrease the resultant possibility and thus result in a bad case match. Fortunately, not counting duplicates does not change the Kolmogorov complexity of the algorithm. The context length is decreased by one for each such duplicate (i.e., when in default mode). Then, notice that traditionally deleterious cycles (e.g., a→a; a→b, b→a; etc.) become an asset because with the feedback comes duplication in the context, which, as may be noted, may beneficially alter sentential semantics. Thus, there is no need to hash to detect cycles (using stacked contexts) because such cycles are beneficial. Finally, the allowance for cycles implies that there is no need to copy the context into a buffer to facilitate data entry.

System 100 may include a computer 110 having processors 120, 130, and 140 connected thereto. Computer 110 may include a processor 112, memory 114, display 116, and input device 118, such as a keyboard or mouse. System 100 may be used to provide an increase in computing capacity by allowing processor 112 to coordinate processors 120, 130, and 140 such that maximal processing capabilities may be achieved.

Example techniques discussed herein may take symmetric case bases and render them random (see, e.g., Chaitin). For example, in effect, a situational experiential system may be randomized to yield a rule-based system. This may advantageously provide knowledge acquisition by way of an easily specified case-based system and an expert system by way of an easily verified rule-based derivative. Creativity may result from the reuse of previously inaccessible knowledge. Symmetric knowledge may result from the transformation of case-based knowledge into rules-based knowledge. New (random) knowledge results on occasion by chance, but more typically results through the application of a sequence of derived rule consequents.

Using explanation-based learning (EBL), a knowledge base may applied to generalize a single example. While EBL may be acceptable under laboratory conditions, such knowledge bases may either build-in the solution (which may be of little to no practical value), or may be far more laborious to construct than would be the corresponding symmetric case base.

An advantageously more logical approach may include breaking cases into coherent rules, which may maximize the reusability of their embedded knowledge. These rules are mutually random by definition. Cases may be specified as they are most convenient for the knowledge engineer, thus minimizing a cost of knowledge acquisition. Knowledge may be amplified because the resultant coherent rules may be validated and may be generally more reusable (see, e.g., '226 patent).

As discussed above, in case-based reasoning (CBR), an issue may pertain to how to generalize cases to increase their applicability. A potential advantage of CBR over rule-based reasoning is that cases may be acquired independent of any understanding of the underlying phenomenon. For this reason, practical case bases may grow to about ten times the size of equivalent rule bases without any deleterious effects. Also, cases may be, for this reason, far easier to maintain (update). Many rule bases may need full knowledge of any and all side effects caused by non-monotonic rules. In contrast, case bases may only need the creation and the use of effective indices into the set of cases to find the closest matching case, along with possibly some adaptive mechanism to fine tune the produced action for the particulars of the situation. Case bases are grown by aggregation, whereas rule bases may be grown through understanding. Thus, it may be more difficult to grow consistent rule bases.

Example techniques discussed herein may provide a cost-effective knowledge-based methodology, which allows a knowledge engineer to specify knowledge in the form of a case base (e.g., which may be advantageously friendly). That case base may then be randomized (e.g., by applying rules and other cases to the cases and rules), to grow segmented (coherent) rule bases having mutually random rules. Maximizing the reusability of the knowledge embedded in the cases may effectively create new validated knowledge, which may serve the goal of knowledge acquisition.

A detailed example is discussed below. A case may include a set of situational variables, which imply a sequence of actions. For example, consider {a, b, c}→(A, B). Situational variables herein may be shown in lower case, while actions may be shown in upper case. Cases may be functional, but may not necessarily be reusable. For example, {a, b}→? Assuming the proper action here, without loss of generality, were (A), then the original case may be broken in two to maximize its reusability, represented as:

{a, b}→(A) (1a)

{A, c}→(B) (2a)

In this example, the presence of actions in the situational set means that they were previously fired. The situational variables, including the previously fired actions, may be evaluated in any order.

It may be noted that not only does the substitution of (1a) and (2a) for the original case cover it, but it properly evaluates {a, b} as well as whenever action A is taken and situational variable c is present. In other words, (1a) and (2a) are a randomization (see, e.g., Chaitin) of the original case.

How can one know (1a)? After all, it may well (also) be that {a, c}→(A). The answer is two-fold. First, the existing rule-based segment is used to reduce the case by extracting out known rules. Here, (1a) would have been previously known. This is the symmetric method. Second, (1a) would be synthesized by pure chance and not lead to a contradiction of any known case (i.e., I/O constraint). This is the random method. Both symmetric and random methods are inherent to any non-trivial randomization (see, e.g., Chaitin). A problem with the random method is that the scale is almost always too small to reveal contradictions.

Symmetric and random rules may be later found to be erroneous. For example, it could be found that {a, b}→(C) and {a, b, x}→(A), where {c}→{x}. The rule base may be updated to:

{d}→{x} (previously resident) (3a)

{c}→{x} (4a)

{a, b, x}→(A) (5a)

{A, c}→(B) (6a)

It may be noted that the context, {a, b, d} would be properly mapped to the action (A); whereas, the original case, {a, b, c}→(A, B), would not be covered by this context. To see that this is automated creativity, a semantics may be ascribed to various symbols. Assume the following:

a=it is cold

b=it is raining

c=one has a cold

d=one has a sore throat

x=one is sick

A=dress warm

B=stay inside

The previously resident rule was that if one has a sore throat, then one is sick. The relevant case was if it is cold, raining, and one has a cold, then one should dress warm and stay inside. The creative rule is if it is cold, raining, and one has a sore throat, one should dress warm. This represents analogical knowledge, which is open under deduction. For example, one cannot stay inside because one needs to seek a medical doctor to obtain medicine.

Next, consider the set of I/O constraints to have the two constraints, { {a, b, c}→(A, B), {a, b}→(C)}. First, assume that the rule base contains rules (3) and (5). This reduces that constraint to {A, c}→(B) (6a). This is obtained via mechanical substitution. Next, suppose that the rule base did not include rule (5a), but rather included only rules (3a) and (6a). The random steps for synthesizing a rule are as follows.

?→(A); ?={a, b}, c is removed because it is found in (6a). This leaves {a, b}→(A), which is a contradiction (i.e., not non-deterministic in this case) on what is known in the I/O constraint vector. Inserting rule (3a), one may obtain: {a, b, x}→(A) (5a), so the presence of {d} serves to distinguish (A) from (C).

A consideration here is that the synthesized rule base, under its most-specific first inference engine, may not contradict an I/O constraint (non-determinism is not allowed); and, it needs to cover all I/O constraints (i.e., so knowledge is not lost). It may be permissible for some rules to be the same as the original cases in order to satisfy these stipulations. An example algorithm, discussed below, is in principle satisfaction of these stipulations.

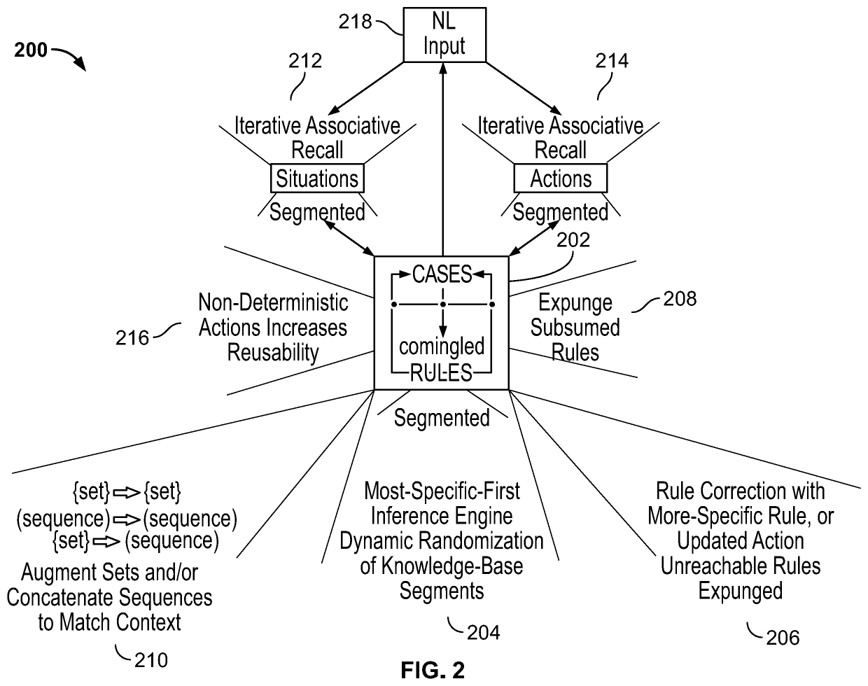

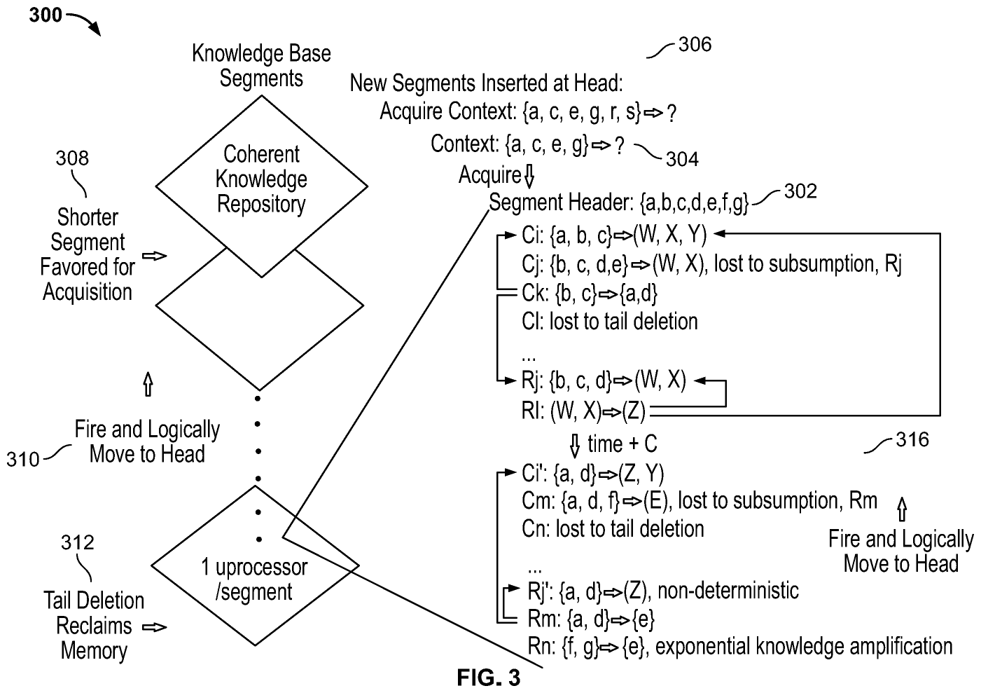

An example system for the randomization of case-based knowledge to rule-based knowledge that is based on the example algorithm is presented in FIG. 2. The figure shows the interrelationship among its constituent parts. FIG. 2 and FIG. 3 are discussed below.

Case bases and their derived rule bases are co-mingled and sub-divided into distinct segments (202). Different segments approximate different domains. Rules reside in the same segments as their parent cases. Every segment contains a header, which contains the union of all of its situational variables (e.g., variables 302). Contexts are acquired (304) by that segment containing all of their situational variables. Otherwise, a new segment (and header) is created (306). Ties for acquisition are resolved in favor of the shorter segment (308) and otherwise arbitrarily. Action transformations are not so tracked because they are linked to situational transforms, which effectively carry them. A most-specific first inference engine is used (204). Cases, rules, and even entire segments are lost, to reclaim memory, when not utilized and their number reaches a dynamically-set limit (e.g., using move-to-the-head, for the segment, whenever a case or a rule, within the segment, is fired) (310). This process, referred to as tail deletion (312), works for the cases and rules, within a segment, in the same manner as it does for the containing segments. It may be noted that cases for which a coherent set of rules are found will be lost to tail deletion, where the segment size is set small enough. Thus, segments evolve to represent distinct concepts of current utility. Each segment will have its own dedicated microprocessor (314).

All cases in a segment comprise a set of non-deterministic I/O constraints. The corresponding rule-based components must (a) cover the same actions as does the case-based segment for the same situations, must (b) not map to different actions (allowing for non-determinism) upon conclusion of processing a context, and must (c) be a randomization of the corresponding case and rule bases—increasing the density of knowledge (see, e.g., Chaitin and Rubin 2007). It may be noted that the optimal randomization is undecidable.

Randomization includes applying the non-empty associated case- and rule-based components to each case and rule in the segment, iteratively transforming them. The cases and rules are applied in the order dictated by a most-specific first agenda mechanism. They will iteratively transform the case- and rule-based components to conclusion.

Whenever a rule is deemed to result in an incorrect action (cases cannot result in an incorrect action by definition), a more-specific rule is acquired to correct it through the most-specific agenda mechanism (206). If such a rule cannot be acquired, then the rule action is updated. The new rule will be a candidate for randomization on the next randomization cycle. As shown in FIG. 2, sets may be augmented and/or sequences may be concatenated to match a context (210). Iterative associative recall may be used for situations (212) and actions (214). Non-deterministic actions may increase reusability (216).

The residue in the case- and rule-based components is iteratively transformed, longest first and otherwise non-deterministically, using known mnemonics—until a further randomization can no longer be had (316). For example, the residue {{a, b, c, d}→(X, Y, X, Z); {a, d, b}→(Y, X, Z, X)} is randomized to the rule set, {{a, b, d}→v1; (Y, X, Z)→V2; {v1, c}→(X, V2); {v1}→(V2, X)}, where v1 and V2 will have been known from other rule and case predicates. This prevents broken boundaries, resulting in meaningless concepts. Situational and action variable names derive from other cases/rules in the segment. Only one iteration was possible for this example. It is noted that that sets may be lexicographically ordered to facilitate pattern matching.

In addition to enhancing the reusability of the knowledge, an advantage of randomization is that it provides multiple paths for satisfying multiple predicates—potentially increasing the potential utility of the knowledge base exponentially, within the same segment. If LHS→LHS or RHS→RHS, then the domain is commutative (see example below). As used herein, “LHS” refers to a left-hand side, and “RHS” refers to a right-hand side (e.g., of a relationship expression, of a rule, of an equation, etc.). Rules are defined by set-based transformations, sequence-based transformations, and may be set to sequence mappings. Variables may be added to sets and as a prefix or a postfix to sequences (i.e., to both sides). This may be done to either obtain a direct or a transformed match of the context (see example below). Case situations or rule antecedents need to be covered by a context to be fired, after which they are logically moved to the head of their segment and the segment to the head of the list of segments. Increasing reusability through the extraction of rules may exponentially increase the likelihood of a covering. Otherwise, a case may need to be acquired to correct an error. Partial coverings may be fatal or equivalent (e.g., everything is lined up to cross a street, but the street crosser did not look at the light) and for this reason are not admissible. The first most-specific case or rule to be covered by a context is the one that is fired. Non-determinism is broken by chance selection. Possibilities are embedded into the case or rule action, where appropriate (e.g., “this is very unlikely to work, but . . . ”). Cases or rules found to be in error have a more-specific version (or replacement) acquired as a correction. Algorithmic (i.e., non-embedded) possibilities are not used because cases and rules are always assumed to be valid until demonstrated to be otherwise.

Upon conclusion of the iterative randomization process, the residue defines a new co-mingled case- and rule-based segment. Duplicate rules are not acquired and subsumed rules are expunged (208). For example, {v1, v2}→(V1) is subsumed by {v1}→(V1); and, thus the former is expunged as being redundant. Seemingly contradictory rules are allowed as being non-deterministic. It may be noted that rules identified as being erroneous are corrected through the acquisition of a more-specific rule or a corrected action where possible; and, otherwise, are expunged along with the now unreachable rules, if any.

Contexts may be the direct translation of sentential forms, as shown by an example in Table 1 below. Cases and rules may be mapped from and to natural language (NL), as shown by an example in Table 2 below (and as shown by NL input 218 in FIG. 2). For example, the sentence, “Now is the time for all good men to come to the aid of their country” may result in the context under knowledge-based transformation of {good men, present time, aid country}. Similar sentential forms will be mapped to the same context for a many-to-one mapping relationship. This may be seen as being creative. The context is the residue of iteratively applying the mapping cases and rule(s) to the sentential input. Similarly, sequences of action variables may be the image of sentential forms under knowledge-based transformation (and vice versa). Again, the relationship is many sentential forms to one action variable sequence. The actions associated with randomizations may also pose questions to gather more information.

Not only can rules randomize cases and other rules, but the residue of such randomizations may serve as an iterative associative memory. For example, if a context, such as {a, b, c} has a superset of least magnitude in the mnemonic definition, vi: {a, b, c, d}, then the user may be queried as to whether or not the full context is vi. More than one such ranked query is possible and practical. Similarly, if an action sequence, such as (A, B, C), is most-closely embedded in the mnemonic definition, Vj: (A, B, C, D), then the user may be queried as to whether or not the full sequence to be specified is Vj. These processes can be iterated. Again, more than one such sequence is possible and practical.

It follows that the density of information, concomitant with the acquisition of self-referential cases, is increasing (see, e.g., Rubin 2007). The creativity exhibited by the system may follow suit. Furthermore, while the number of segments may be increasing, each segment may run on a parallel processor. Hence, while the capabilities of the system grow super-linearly without bound, its resource requirements may grow linearly without bound. It follows that the system may match and exceed human-level intelligence at appropriate scales of realization.

The example algorithm is illustrated below using a simple weather forecasting example. Let, b [symbol] =barometer rising/falling; c=cloudy; f=freezing; w=warm; p=precipitation; r=rain; s=snow; and, l=clear. Again, lowercase letters indicate situational variables, while uppercase letter indicate actions, or the Boolean indication that an action was taken if used on the LHS. Set brackets and sequential braces are omitted here to enhance readability. It is noted that b↓↓ is interpreted to mean that the barometer is falling very fast and similarly b↑↑ is interpreted to mean that the barometer is rising very fast. Predicate combinations and sequences may also be ascribed a semantics using NL. The most-specific predicate sequences are parsed first. Table 1 provides a few examples of translating NL into variable form. The user enters the LHSs in NL and the system replies with the RHSs in NL. Table 2 show a few symbolic rules and their NL translations.

First, sequence is not important to the RHS. Thus, all cases and rules in the weather forecasting domain are commutative so a→B implies b→A. Assume the following optimization rule:

R0: b↓ b↑→{ }|( ) (1)

Consider the following pair of weather cases, as shown in Table 1 and Table 2.

TABLE 1
Sample Natural Language (NL) Translations

| Minimal | Set (LHS) | |
|---|---|---|
| Symbols | Interpretation | Sequence (RHS) Interpretation |
| b ↓↓ l | A storm is | The barometer is rapidly falling and it's |
| | unexpectedly | clear. |
| | approaching. | |
| p p w | It is precipitating | It is raining cats and dogs. |
| | hard and it is | |
| | warm. | |
| p r | It is pouring. | It is pouring. |

TABLE 2
Sample Rules and Their Translations

| Minimal | Set (LHS) | |
|---|---|---|
| Symbols | Interpretation | Sequence (RHS) Interpretation |
| b ↓ c → P | If the barometer is | precipitation is expected. |
| | falling and it is | |
| | cloudy | |
| p f → S | If precipitation and | snow is expected. |
| | freezing temperatures | |
| | are likely | |
| b ↓ l → C | If the barometer is | it is expected to become cloudy. |
| | falling and it's clear | |

C1: b↓ c w→R

C2: b↓ c f→S (2)

Cases C1 and C2 are randomized by applying (3) to (2).

R1: b↓ c→P (3)

Next, C1 and C2 are randomized by substitution of R1 (it could also be a case) into them with the result:

R2: p w→R

R3: p f→S (4)

At this point, assume that the system acquires the case:

C3: b↑ c→L (5)

Next, it is supplied with the context, b↓ l, which has no literal match in the case or rule bases. However, it can be transformed by adding b↓ to the LHS set and adding B↓ as a prefix or a postfix to the RHS (again, in this example, both sides are sets):

R4: b↓ b↑ c→B↓L so by (R0), c→B↓L (6)

Furthermore, by adding b↓ to both sides, the following is obtained:

R5: p→B↓ C (R1)→B↓↓ L (R4) (7)

R5 makes conceptual sense. R5 may be substituted for R1 in all candidate derivations. This pairing shares a common predicate (i.e., p).

Next, assume that the complete context is given as {b↓ c r}. This context may be processed by the remaining case and six rules as follows, where again,

C3: b↑ c→L

R0: b↓ b↑→{ }|( )

R1: b↓ c→P

R2: p w→R

R3: p f→S

R4: b↓ l→C

R5: b↓↓ l→P

b↓ c r(R1)→P R (8)

At this point, it may be assumed that the context (8) is maximally randomized (i.e., has the fewest predicate terms) with the result, “It is pouring.” In summary, this example illustrates how cases and rules may interact to eliminate C1 and C2 and create several new rules to randomize the knowledge base. While the size of the resulting base is greater in this case, the resulting density of knowledge is greater than it was before this amplification as evidenced by the properly matched supplied contexts. Again, fired cases and rules are moved to the head of the cache. In this way, the cache size determines what to save or allow to be recalculated (i.e., under a most-recently-used OS policy).

As another example, rules may be represented by schemas, as discussed further below.

TABLE 3
A Simple Weather Features Schema

Define Boolean Weather_Change_Feature (var x, t1,

t2; t):

/* In general, schemas may call other schemas. */
Randomly Select x ∈ {pressure, humidity,

temperature};

Randomly Select t1, t2 ∈ {t, t-1, t-2, t-3}

Such That t2 > t1;

If x[t2] Randomly Select op ∈ {>, <} x[t1]

Return (1);

Return (0).

A simple schema is presented in Table 3, which is aligned with meteorological information. Here, an analyst has created a schema to detect weather changes in the form of Boolean features. The search space for this schema is 3×6×2=36 possible instances. The first random select statement allows for three choices (i.e., for pressure, humidity, or temperature). The six combinations for the second random select statement are derived from taking n=4 items, r=2 at a time, where the number of combinations, c, is defined by,

$$c = \frac{n !}{r ! ( n - r ) !} .$$

Finally, it may be noted that there are two random choices for the final set of relational operators, {>, <}. Tables 4 and 5 show sample features, which are instances of their parent schema, which is found in Table 3. They may be automatically discovered and validated through computational search. Table 4 presents one of 36 possible instances of this schema:

TABLE 4
A “Pressure” Instance of the Simple Weather Features Schema

Define Boolean Pressure_Increase_Feature

(pressure, t):

If pressure[t] > pressure [t-1]

Return (1);

Return (0).

Another of 36 possible instances of this schema is presented in Table 5:

TABLE 5
A “Humidity” Instance of the Simple Weather Features Schema

Define Boolean Humidity_Decrease_Feature

(humidity, t):

If humidity[t-1] < humidity [t-3]

Return (1);

Return (0).

To illustrate the significance of representation to computational efficiency, consider the constraint, “Such That t2>t1” in Table 3. By realizing that t2>t1 is symmetric (read redundant) with t2<t1, an analyst may cut the search space, and thus the search time, by at least half. That is, this realization enables the analyst to prune the synthesis of increasing and decreasing Boolean features from occurring twice, a priori. The inclusion of each such constraint and each reduction in the number of alternative choices may reduce the size of the search space by some scale. Thus, it may be computationally more efficient to minimize the amount of search by maximizing the number of schemas. This is a variant of the principle known in numerical analysis as the inverse triangle inequality. Here, ∥x∥+∥y∥≤∥x+y∥, where the norm, indicated by the parallel brackets, refers to the magnitude of a schemas search space (e.g., 36 for Table 3). The summing of schemas x and y, before taking the norm (right-hand side), implies the relaxing of one or more search constraints so that the resulting single schema covers at least the same search space as the union of its constituent individual schemas (left-hand side). Schema sizes, in bits, are constrained such that |x+y|≤max {|x|, |y|}.

The use of schemas may be significantly more analyst friendly than is the use of rule-based constraint systems, because it may be far easier for analysts to provide examples than to correctly specify general-purpose rules (i.e., determine causality).

As discussed above, an example problem addressed by the discussion herein, pertains to how to generalize knowledge through self-application (i.e., randomization). In summary, knowledge may be defined to be a sequence of symbols, which define the actions of a fixed interpreter. These sequences map a set of mutually random inputs to an associated non-deterministic set of outputs. By setting these inputs to these sequences and their associated outputs to their randomized sequences, the mapping sequences here may randomize domain-specific knowledge. Such generalization may be iteratively performed through the coherent actions of many such sequences. In effect, declarative knowledge may be exponentially reduced and mapped to procedural knowledge. Example techniques discussed herein may be applied to mapping a case base to a rule base. Knowledge, in the form of cases (i.e., unlike rules), is readily captured. Case-based knowledge is automatically randomized into rules enabling greater reusability. This may be evidenced as autonomous knowledge-based creativity in practice. Further, a user may integrate scalable reusable functional programming with the approach, thus making for extensible intelligent systems.

Example techniques discussed herein may provide the following advantageous features. It is noted that there may be many more advantageous features than are listed below.

(a) Knowledge is self-applied to achieve a randomization. This may be achieved by mapping case knowledge to rule-based knowledge.

(b) Non-deterministic case/rule substitution may lead to exponential knowledge amplification; albeit, potentially with less validity than a strictly deterministic substitution.

(c) Declarative knowledge may be exponentially reduced and mapped to procedural knowledge.

(d) Induced rules are constrained by the mutually random I/O cases and their rule derivatives.

(e) Case-based knowledge is readily captured; while, rule-based knowledge is more reusable (in general).

(f) By increasing the applicability of knowledge, it becomes more reusable and, as a consequence, coherent.

(g) A solution to the problem of how to generalize cases to increase their applicability is provided.

(h) Segmented (coherent) rule bases of mutually random rules are aggregated.

(i) Maximizing the reusability of the knowledge embedded in the cases leads to the creation of coherent knowledge, which serves the goal of knowledge acquisition.

(j) The methodology discussed herein may create analogical knowledge, which is open under deduction.

(k) Case-based segments are comingled with their derived rule-based segments for a randomized residue.

(l) Knowledge subsumed by validated knowledge is expunged. Case-based knowledge can thus be replaced by more-general rule-based knowledge.

(m) Every segment contains a header, which includes the union of all of its situational variables. Contexts are acquired by that segment containing all of their situational variables. Otherwise, a new segment (with header) is created.

(n) Ties for acquisition are resolved in favor of the shorter segment and otherwise arbitrarily.

(o) Cases, rules, and even entire segments are lost, to reclaim memory, when not utilized and their number reaches a dynamically-set limit (e.g., using move-to-the-head, for the segment, whenever a case or a rule, within the segment, is fired). This will expunge unnecessary cases.

(p) Each segment runs its own dedicated microprocessor in parallel.

(q) All cases in a segment comprise a set of non-deterministic I/O constraints.

(r) Rule randomization increases the density of knowledge.

(s) Cases and rules are applied in the order dictated by a most-specific first agenda mechanism.

(t) Broken boundaries, resulting in meaningless concepts, are prevented by applying known cases and rules in the same segment to transform other cases and rules—instead of searching for and extracting maximally common subsets and subsequences and wasting time querying for a mnemonics, if any.

(u) The methodology discussed herein provides for commutative domains, which allows truly novel situational and/or action knowledge to emerge from mechanical transformation in combination with state space search.

(v) Optimization cases can be randomized and iteratively propagate optimizations through their resident segments.

(w) Cases, rules, and their containing segments have their storage managed by a move-to-the-head scheme using tail deletion. In this manner, validated rules replace tail-deleted cases and can serve as I/O constraints.

(x) Sentential forms can be mapped many to one on to a context; and, produced actions can be mapped one to many on to sentential forms (and vice versa). Actions may also pose questions.

(y) The residue of randomization can serve as an iterative associative memory for the specification of contexts and actions. Questions may be posed.

(z) While the capabilities of the system grow super-linearly without bound, its commensurate resource requirements grow linearly without bound. It follows that the system may match and exceed human-level intelligence at appropriate scales of realization.

As an alternative to the discussion above, a similar technique could be constructed so that a knowledge base impinges on a domain-specific representation of knowledge. This defines explanation-based learning (EBL). However, this does not necessarily utilize cases as natural I/0 constraints. Moreover, EBL applies external knowledge to generalize primary knowledge; whereas, the discussion above applies primary knowledge to generalize itself. Thus, EBL tends to build that generalizing knowledge in with scale; whereas, the discussion above tends to automatically discover generalizing knowledge as it scales in a specific domain. In other words, EBL is unnecessarily limited. Also, deterministic systems may incur far fewer errors, but may be non-creative as a consequence. Substitution of non-deterministic rules into cases may induce erroneous actions. This is due to the use of hidden variables, or implied contexts. More-specific rules may be acquired to correct for these errors. Thus, rules may evolve to be as general as possible, but no more so. There may be no alternative design configuration, at least with scale.

In general, the example techniques discussed herein may be realized on a massively parallel digital computer or even on a photonic neural network. Both allow for the symbolic processing of information; and, both are capable of generalized modus ponens. Intra-segment communication may occur by way of shared variables. Inter-segment communication occurs by way of non-monotonic rules. Both modes of communication are inherently important to intelligent functionality. Given a society of such minds (e.g., Minsky), a generalized intelligence can emerge.

Example aspects discussed herein may be implemented as a series of modules, either functioning alone or in concert with physical electronic and computer hardware devices. Example techniques discussed herein may be implemented as a program product comprising a plurality of such modules, which may be displayed for a user. As used herein, the term “module” generally refers to a software module. A module may be implemented as a collection of routines and data structures that performs particular tasks or implements a particular abstract data type. Modules generally are composed of two parts. First, a software module may list the constants, data types, variables, and routines that may be accessed by other modules or routines. Second, a module may be configured as an implementation, which may be private (i.e., accessible only to the module), and which contains the source code that actually implements the routines or subroutines upon which the module is based. Such modules may be utilized separately and/or together locally and/or remotely to form a program product thereof, that may be implemented through non-transitory machine readable recordable media.

Various storage media, such as magnetic computer disks, optical disks, and electronic memories, as well as non-transitory computer-readable storage media and computer program products, can be prepared that can contain information that can direct a device, such as a micro-controller, to implement the above-described systems and/or methods. Once an appropriate device has access to the information and programs contained on the storage media, the storage media can provide the information and programs to the device, enabling the device to perform the above-described systems and/or methods.

For example, if a computer disk containing appropriate materials, such as a source file, an object file, or an executable file, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods, and coordinate the functions of the individual systems and/or methods.

Features discussed herein are provided as example techniques that may be implemented in many different ways that may be understood by one of skill in the art of computing, without departing from the discussion herein. Such features are to be construed only as example features, and are not intended to be construed as limiting to only those detailed descriptions.

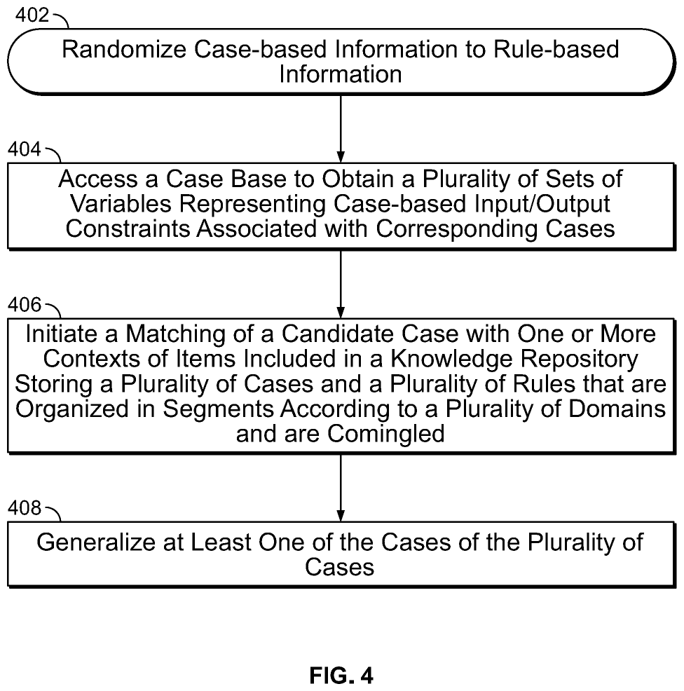

FIG. 4 is a flowchart illustrating example operations of the system of FIG. 1, according to example embodiments. As shown in the example of FIG. 4, case-based information may be randomized to rule-based information (402).

A case base may be accessed to obtain a plurality of sets of variables representing case-based input/output constraints associated with corresponding cases (404).

A matching may be initiated of a candidate case with one or more contexts of items included in a knowledge repository storing a plurality of cases and a plurality of rules that are organized in segments according to a plurality of domains and are comingled (406). At least one of the cases of the plurality of cases may be generalized (408).

For example, generalizing at least one of the cases may include non-deterministic substitution.

For example, generalizing at least one of the cases may include self-application of knowledge to provide a randomization.

For example, case-based segments may be comingled with associated derived rule-based segments in the knowledge repository.

For example, generalizing at least one of the cases may include expunging at least one subsumed rule of the plurality of rules.

For example, generalizing at least one of the cases may include applying non-empty associated case- and rule-based components to each case and each rule in a corresponding one of the segments, iteratively transforming the each case and each rule.

For example, each of the segments may include a header, wherein the header includes a union of a plurality of situational variables corresponding to situational variables of each of the plurality of cases included in the each of the segments.

One skilled in the art of computing will appreciate that many other types of techniques may be used for randomizing case-based knowledge to rule-based knowledge, without departing from the discussion herein.

Features discussed herein are provided as example techniques that may be implemented in many different ways that may be understood by one of skill in the art of computing, without departing from the discussion herein. Such features are to be construed only as example features, and are not intended to be construed as limiting to only those detailed descriptions.

For example, the one or more processors (e.g., hardware device processors) may be included in at least one processing apparatus. One skilled in the art of computing will understand that there are many configurations of processors and processing apparatuses that may be configured in accordance with the discussion herein, without departing from such discussion.

In this context, a “component” or “module” may refer to instructions or hardware that may be configured to perform certain operations. Such instructions may be included within component groups of instructions, or may be distributed over more than one group. For example, some instructions associated with operations of a first component may be included in a group of instructions associated with operations of a second component (or more components). For example, a “component” herein may refer to a type of functionality that may be implemented by instructions, which may be located in a single entity, or may be spread or distributed over multiple entities, and may overlap with instructions and/or hardware associated with other components.

In this context, a “memory” may include a single memory device or multiple memory devices configured to store data and/or instructions. Further, the memory may span multiple distributed storage devices. Further, the memory may be distributed among a plurality of processors.

One skilled in the art of computing will understand that there may be many ways of accomplishing the features discussed herein.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. A method comprising:
randomizing case-based information to rule-based information by:
accessing a case base to obtain a plurality of sets of variables representing case-based input/output constraints associated with corresponding cases;
initiating a matching of a candidate case with one or more contexts of items included in a knowledge repository storing a plurality of cases and a plurality of rules that are organized in segments according to a plurality of domains and are comingled; and
generalizing at least one of the cases of the plurality of cases.

2. The method of claim 1, wherein generalizing at least one of the cases includes non-deterministic substitution.

3. The method of claim 1, wherein generalizing at least one of the cases includes self-application of knowledge to provide a randomization.

4. The method of claim 1, wherein case-based segments are comingled with associated derived rule-based segments in the knowledge repository.

5. The method of claim 1, wherein generalizing at least one of the cases includes expunging at least one subsumed rule of the plurality of rules.

6. The method of claim 1, wherein generalizing at least one of the cases includes applying non-empty associated case- and rule-based components to each case and each rule in a corresponding one of the segments, iteratively transforming the each case and each rule.

7. The method of claim 1, wherein each of the segments includes a header, wherein the header includes a union of a plurality of situational variables corresponding to situational variables of each of the plurality of cases included in the each of the segments.

8. A system comprising:
at least one hardware device processor; and
a computer-readable storage medium storing instructions that are executable by the at least one hardware device processor to randomize case-based information to rule-based information by:
accessing a case base to obtain a plurality of sets of variables representing case-based input/output constraints associated with corresponding cases;
initiating a matching of a candidate case with one or more contexts of items included in a knowledge repository storing a plurality of cases and a plurality of rules that are organized in segments according to a plurality of domains and are comingled; and
generalizing at least one of the cases of the plurality of cases.

9. The system of claim 8, wherein generalizing at least one of the cases includes non-deterministic substitution.

10. The system of claim 8, wherein generalizing at least one of the cases includes self-application of knowledge to provide a randomization.

11. The system of claim 8, wherein case-based segments are comingled with associated derived rule-based segments in the knowledge repository.

12. The system of claim 8, wherein generalizing at least one of the cases includes expunging at least one subsumed rule of the plurality of rules.

13. The system of claim 8, wherein generalizing at least one of the cases includes applying non-empty associated case- and rule-based components to each case and each rule in a corresponding one of the segments, iteratively transforming the each case and each rule.

14. The system of claim 8, wherein each of the segments includes a header, wherein the header includes a union of a plurality of situational variables corresponding to situational variables of each of the plurality of cases included in the each of the segments.

15. A non-transitory computer-readable storage medium storing instructions that are executable by at least one hardware device processor to randomize case-based information to rule-based information by:
accessing a case base to obtain a plurality of sets of variables representing case-based input/output constraints associated with corresponding cases;
initiating a matching of a candidate case with one or more contexts of items included in a knowledge repository storing a plurality of cases and a plurality of rules that are organized in segments according to a plurality of domains and are comingled; and
generalizing at least one of the cases of the plurality of cases.

16. The non-transitory computer-readable storage medium of claim 15, wherein generalizing at least one of the cases includes non-deterministic substitution.

17. The non-transitory computer-readable storage medium of claim 15, wherein generalizing at least one of the cases includes self-application of knowledge to provide a randomization.

18. The non-transitory computer-readable storage medium of claim 15, wherein case-based segments are comingled with associated derived rule-based segments in the knowledge repository.

19. The non-transitory computer-readable storage medium of claim 15, wherein generalizing at least one of the cases includes expunging at least one subsumed rule of the plurality of rules.

20. The non-transitory computer-readable storage medium of claim 15, wherein generalizing at least one of the cases includes applying non-empty associated case- and rule-based components to each case and each rule in a corresponding one of the segments, iteratively transforming the each case and each rule.
